(19) United States
(12) Patent Application Publication
(10) Pub. No.: US 2003/0085174 A1
(43) Pub. Date: May 8, 2003

(54) On-site biological treatment of contaminated fluids

(76) Inventors: Mark E. Zappi, Starkville, MS (US); J. Alex Thomasson, Starkville, MS (US); Eugene P. Columbus, Starkville, MS (US); Timothy N. Burcham, Starkville, MS (US); Abdolhamid Borazjani, Starkville, MS (US)

Correspondence Address: Supervisor, Patent Prosecution Services, PIPER MARBURY RUDNICK & WOLFE LLP, 1200 Nineteenth Street, N.W., Washington, DC, 20036-2412, US

(21) Appl. No.: 09/837,189

(22) Filed: Apr. 19, 2001

(51) Int. Cl. C02F 1/28

(52) U.S. Cl. 210/691; 210/688

(57) ABSTRACT

The invention relates to a sustainable process for treating contaminated fluids that utilizes a cellulose-based medium to adsorb contaminants in contaminated fluids and vapors. First, the cellulose-based material is tightly packed into a column. Contaminated fluid is then passed through the column to provide intimate contact between the contaminated fluid and the cellulose-based material. As the contaminated fluid flows through the column, the cellulose-based material adsorbs the contaminants (both organic and inorganic contaminants) due to the adsorptive properties of the cellulose-based material. The column is operated until the attenuation capacity of the cellulose-based material within the column is reached (i.e., when contaminants are found in the effluent). The cellulose-based material is then removed and composted and a new cellulose-based material is packed into the column. Composting is used to reduce the volume of the spent cellulose-based material and degrade and concentrate the contaminants. The final product from the composting step is substantially free from contaminants.

### BACKGROUND OF THE INVENTION

1. Field of the Invention

The present invention relates to a process that uses a combination of adsorption and biological treatment mechanisms to remove contaminants from contaminated fluids or vapors. In particular, the process incorporates the use of a two-stage system with the first stage involving the adsorption of contaminants onto a cellulose-based adsorbent media. The second stage involves the composting of the cellulose-based adsorbent media. The composting stage results in a significant reduction of adsorbent mass, the biodegradation of biodegradable adsorbates, and concentration in post-composted residuals of the non-biodegradable adsorbates. The process according to the present invention is viable for the treatment of wastewater, groundwater, and air.

### DISCUSSION OF THE BACKGROUND

Pollution of aqueous solutions and air is an ever expanding problem in the modern world. An ever-growing number of toxic pollutants are produced by industries, such as, for example, textile industries, chemical industries, pharmaceutical industries, pulp and paper industries, and food processing plants. The majority of these toxic pollutants are released within two primary fluid physical states: water and air. As the scope of water and air-borne pollutant production increases worldwide, the dangers imposed by these released pollutants on the environment also increases. Additionally, environmental regulations are requiring that these released fluid streams contain less and less pollutants. In fact, some treatment processes that were acceptable options at one point in time are now obsolete because lower treatment standards are required as new environmental regulations are implemented on the state and federal level. Thus, there is an ever growing need for more efficient and economic fluid purification methods.

In response to the ever-changing environmental regulations, many wastewater purification methods have been developed. Key examples for waste constituent treatment include chemical oxidation, activated carbon adsorption, electrochemical oxidation, and bioremediation.

Bioremediation is the most common treatment process for organic contaminated waters. In bioremediation, pollutants serve as a food source, generally as a source of carbon and/or nitrogen, for microorganisms. Bacterial metabolism converts the pollutants to metabolites generally with a simple chemical structure, sometimes degrading the pollutants completely to carbon dioxide and water within an aerobic process or to methane and carbon dioxide within an anaerobic process. However, known bioremediation processes suffer from a number of inherent disadvantages. For example, a major result of the increased use of these processes is an increasing quantity of sludge, which presents serious disposal problems due to increasingly restrictive policies on dumping or spreading untreated sludge on land and at sea. The cost of sludge disposal today may be greater than the sum of other operating costs of wastewater treatment. Another disadvantage inherent in bioremediation processes is that these processes often do not reduce the levels of organic pollutants to reasonable levels (i.e., preferably less than about 0.1 parts per million [ppm]) at reasonable rate (i.e., preferably less than about 24 hours). Additionally, the influent to be treated often does not contain sufficient amounts of carbon and/or nutrients to sustain an effective biomass. These shortcomings can be overcome via co-substrate amending, but this tends to be very costly and may disrupt targeted metabolic activities.

Chemical oxidation offers an alternative method for wastewater treatment. Chemical oxidation processes use chemicals, often times in conjunction with UV photolysis, to break down contaminants within polluted fluids. However, the presence of hydroxyl radical scavengers within the influents, turbid waters, or waters having poor influent UV transmissivity adversely impacts the oxidation process performance. Additionally, chemical oxidation techniques may break down contaminants into refractory by-products that are also of environmental concern. In some cases, these by-products may have to be further treated using additional treatment time within the oxidation reactor or in another treatment process, such as biological treatment. For example, when using chlorine oxidation, it is possible that toxic organochlorine compounds will be formed, which requires further water dechlorification.

Electrochemical water purification methods is another wastewater treatment option. Electrochemical water purification is performed by running the wastewater to be purified through an electrolytic electrolyzer cell, in which oxidation of the pollutants occurs. Much like chemical oxidation, electrochemical methods have the disadvantages of incomplete oxidative-destruction of the water polluting substances and the formation of persistent by-products of incomplete oxidation, resulting in the generation of new water pollutants.

Yet another very popular fluid treatment process is adsorption onto activated carbon. The functioning mechanism of this process is the adsorption of pollutants onto the sorption sites of activated carbon surfaces. The attraction between the adsorbent surface adsorption sites and the adsorbates is primarily physical (e.g., van der Waals attractive forces), but in some cases, chemisorption is possible. Activated carbon processes are typically conducted by first loading a column with the activated carbon. The influent (water or air) is then passed through the column allowing the pollutants (adsorbates) to be adsorbed onto the adsorption sites. After a period of operation, all of the adsorption sites become occupied and the adsorbent is of no further use. At this point, the adsorbent is considered “spent”. One distinct disadvantage of activated carbon systems is that disposal of the spent carbon can be problematic. Often times, regeneration is used to recycle the spent carbon, but this regeneration is costly. Placement of the spent carbon within landfills has been used for disposal of the spent carbon but this does not eliminate the spent activated carbon.

As discussed above, numerous methods of purifying contaminated fluids exist. However, these methods often do not result in optimal purification, they require a great deal of energy, and/or they produce additional undesired waste products or water pollutants. Accordingly, it remains a goal of those of ordinary skill in the art to obtain new processes that improve treatment and reduce technical complexity in a cost-effective manner.

In order to address these problems present in the art, the present inventors have developed a two-stage bioabsorption treatment process that utilizes a cellulose-based material (adsorbent) to remove contaminants (adsorbates) from contaminated fluids (water or vapors) via adsorption. After the adsorbent becomes spent, the cellulose material is placed within a composter which results in the degradation of both the adsorbent and biodegradable absorbates via biological mechanisms. Non-biodegradable adsorbates are concentrated within the compost residuals. The combination of cellulose-based adsorption and composting provides a novel and functional two-stage process that addresses the shortcomings of prior treatment methods. Further, the process of the present invention is viable for wastewater, groundwater, and air phase treatment.

### SUMMARY OF THE INVENTION

It is an object of the present invention to provide a process for the treatment of contaminated fluids that utilizes a cellulose-based medium to treat the contaminated fluid using an adsorption mechanism.

It is another object of the present invention to provide a process for the treatment of contaminated fluids that utilizes a treatment medium that is suitable for composting.

It is a further object of the present invention to biodegrade the spent cellulose-based medium (e.g., plant-based adsorbent) and biodegradable adsorbates (i.e., adsorbed pollutants) within a composter.

It is yet another object to concentrate the non-biodegradable adsorbates within the compost residuals to form a solid matrix in which the pollutants are easily managed.

It is another object of the present invention to provide a process for the treatment of contaminated fluids that can be implemented in a cost effective manner.

It is another object of the present invention to provide a sustainable process for the treatment of contaminated fluids that can be implemented for treatment of biodegradable or non-biodegradable pollutants that are adsorbable.

It is yet another object of the present invention to provide a method for treating contaminated fluids or vapors.

With the foregoing and other objects, advantages and features of the invention that will become hereinafter apparent, the nature of the invention may be more clearly understood by reference to the following detailed description of the preferred embodiments of the invention and to the appended claims.

### BRIEF DESCRIPTION OF THE DRAWINGS

FIG. 1 is a schematic representation of the treatment process of the present invention.

### DESCRIPTION OF THE PREFERRED EMBODIMENTS

The use of plant-based adsorbents is known. Various plant-based adsorbents such as kenaf, peanut hulls, tree bark, and hay have been proven to be effective for removal of both organic and inorganic adsorbates. In particular, it has been discovered that cellulose-based materials such as are used in the process of the present invention are resistant to water logging and are structurally stable when exposed to overburden loads, thereby allowing tight, sturdy packing of a column. Additionally, it has been determined that cellulose-based materials are resistant to biodegradation under saturated column conditions. Also, flow distribution and handling properties of cellulose-based materials have been found to be extremely stable. In addition, cellulose-based plant materials have good adsorption characteristics that make them ideally suited as an adsorption medium.

In view of these favorable characteristics and good adsorption qualities of cellulose-based plant materials, the present inventors have developed a two stage process for treating contaminated fluids that utilizes a cellulose-based plant material. In the first stage, the cellulose-based plant material adsorbs both organic and inorganic contaminants (i.e., pollutants) present in contaminated fluids. In the second stage, after the cellulose-based plant material has adsorbed its maximum amount of contaminants, the spent cellulose-based material is composted to degrade and concentrate the contaminants and reduce the volume of the spent material.

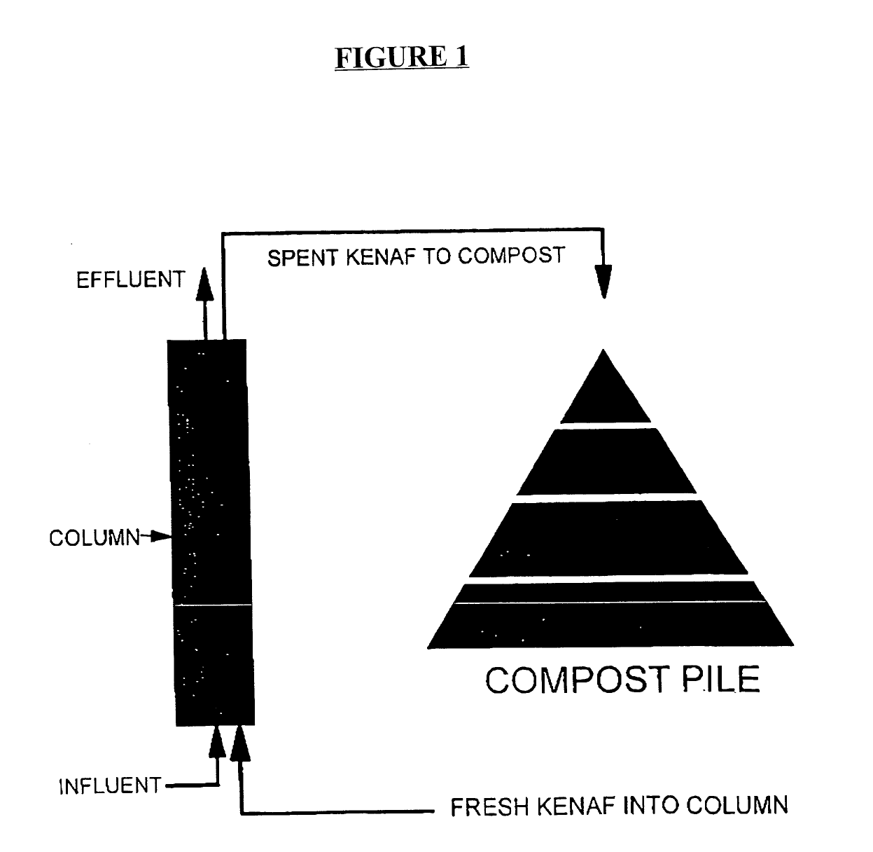

The present invention is a sustainable treatment process for contaminated fluids that can be implemented for the treatment of most organic and inorganic pollutants that are adsorbable and/or biodegradable. A schematic representation of the treatment process according to the present invention is shown in FIG. 1. FIG. 1 also shows the simplicity of the treatment system used in the treatment process of the present invention. As shown in FIG. 1, the treatment system is simply a column packed with a cellulose-based plant material. Examples of suitable cellulose-based materials include kenaf, hay, wood chips, and peat. However, any cellulose-based material capable of adsorption is suitable for use in the present invention.

The process for biologically treating contaminated fluids involves the adsorption of contaminants onto a cellulose-based material. First, the cellulose-based material is tightly packed into a column. The contaminated fluid is then passed through the column, such as by using up-flow hydraulics, to provide intimate contact between the contaminated fluid and the cellulose-based material. As the contaminated fluid flows through the column, the cellulose-based material serves as an adsorbent and removes the contaminants (both organic and inorganic contaminants) due to the adsorptive properties of the cellulose-based medium. The column is operated until the adsorptive capacity of the cellulose-based material within the column is reached (i.e., when contaminants are found in the effluent). The cellulose-based material is now said to be “spent”. Columns can be operated in either parallel or series-plumbed mode. Once the cellulose-based material is spent, the spent material is removed and composted and new cellulose-based material is packed into the column.

Composting is used to reduce the volume of the spent cellulose-based material (i.e., the adsorbent) and biochemically degrade the adsorbed organic contaminants and concentrate the inorganic contaminants via biotreatment. Composting is accomplished using developed compost practices. The functioning mechanism of the compost stage is bacteria which degrade carbon sources within the spent cellulose matrix and the resulting composted product containing complexed non-biodegradable adsorbates. The composting method is not limited, and includes such composting methods such as drum composters, windrow compost beds, and packed column compost units. Compost formulations used in the initiation of the compost stage includes combinations of old compost, vegetable wastes, and fresh cellulose medium.

On average, over 50% of the volume of the spent cellulose-based material is reduced, with an almost complete biodegradation of the pollutants obtainable within the compost bed. Kenaf composting experiments in accordance with the process of the present invention have shown that fractions of fresh kenaf in excess of 70% (w/w) had volume reductions greater than 50%. Thermophilic composting has been found to yield higher degradation rates of the cellulose material and higher volume reductions. Mesophilic composting also degrades the cellulose material, but it does not have as high a volume reduction of the cellulose-based material as thermophilic composting. In particular, thermophilic composting obtained a volumetric reduction rate of approximately 1% volume per day, whereas mesophilic composting only achieved a volumetric reduction rate of 0.3% per day.

The final product from the composting step is a humus-based material that is substantially free of biodegradable contaminants. Non-biodegradable adsorbates are concentrated within the final composted product. The composted material has marketable value as a stabilized value added fertilizer or soil amendment. (Maynard, 1995). One advantage of composting the cellulose-based material is that the composting results in an on-site degradation and concentration of the adsorbed contaminants. There is no need to transport the spent cellulose-based material off-site for destruction, such as is required with activated carbon systems.

Both organic and inorganic contaminants can be removed according to the treatment process of the present invention. Examples of biodegradable contaminants that are adsorbable include, but are not limited to, 2, 4, 6-trinitrotoluene (TNT), methyl-tertiary-butyl ether (MTBE), polycyclic aromatic hydrocarbons (PAH), petroleum products, polychlorinated biphenyls (PCBs), and chlorinated solvents such as trichloroethane and tetrachloroethane. Examples of non-biodegradable pollutants capable of concentration by the process of the present invention include heavy metals (e.g., lead, cadmium, mercury, zinc, arsenic, chromium, nickel, copper), nitrate, ammonia, and phosphates. One particularly attractive aspect with regard to the treatment of TNT-contaminated waters using the process of the present invention is that trinitrobenzene (TNB), a well-known problem by-product of TNT oxidation, is not formed.

The process of the present invention has many advantages over current systems such as activated carbon systems. For example, the treatment system (i.e., column) of the present invention is purposefully simple with low maintenance requirements. Loading of activated carbon into adsorbers is operationally challenging because of the brittle nature of the carbon. Also, regeneration of the spent activated carbon requires special reactors that use extremely high temperatures and pressures. Because the cellulose material in the column is a cellulose-based fibrous plant, it is readily renewable and inexpensive to obtain, unlike activated carbon, which is much more expensive. Activated carbon typically costs approximately $1.50/pound, while kenaf typically costs less than $0.20/pound. Hay, peanut hulls, and wood chips are even cheaper on a per pound basis. The cellulose-based plant fibers are easily prepared using processing techniques that economically wash, crush, and segregate the various fractions. Also, activated carbon manufacturing must be done within special industrial facilities to accommodate the high temperatures and pressures of this intensive manufacturing process. Cellulose materials can be grown locally using conventional farming practices and is prepared for column usage via very simple processing techniques such as chopping and air drying. High percentages of pollutants have been adsorbed using the cellulose adsorbents of the present invention. For example, experiments using the process of the present invention have yielded TNT loading capacities on kenaf as high as 10 mg/g and have removed pentachlorophenol (PCP) within a water influent to sub-analytical detection levels.

Having generally described this invention, a further understanding can be obtained by reference to certain specific examples which are provided herein for purposes of illustration only and are not intended to be limiting unless otherwise specified.

### EXPERIMENTAL DATA

A small pilot column study was performed in which three kenaf packed (kenaf core fibers) columns plumbed in series where used to treat groundwater containing 1.7 mg/l pentachlorophenol (PCP) and 0.3 mg/l polycyclic aromatic hydrocarbons (PAHs). Over 100 gallons were tested using this system. In the case of the PCP, approximately 90% of the PCP that were flowed through the columns were removed by Column 1, with the balance being removed in Column 2. For PAHs, about 94% of the PAHs were removed within Column 1 and the balance removed from Column 2. Column 3 was never challenged with the adsorbates during this study because of complete capture by Columns 1 and 2. After column testing, the kenaf from Columns 1 and 2 were composted within small compost unit for a period of 60 days. After 60 days of incubation, the compost units had removed over 75% of all the adsorbates from the kenaf.

Additional testing has generated a series of adsorption isotherms for TNT using both kenaf core and crushed whole kenaf stalk. The data indicate that the adsorptive capacity for TNT for both adsorbents tested was about 7 mg/kg, which is well within the range reported for activated carbon treatment of TNT. Also, the slope of the isotherms were very similar to those observed with activated carbon. Consequently, the process of the present invention is a direct competitor to activated carbon in the marketplace.

Composting experiments on uncontaminated kenaf indicate that composting can degrade kenaf at a rate of about 0.7% volume per day. Carbon dioxide evolution and oxygen utilization has verified the high level of biological activity supported within the compost units during kenaf composting.

The invention of this application is described above both generically, and with regard to specific embodiments. A wide variety of alternatives known to those of ordinary skill in the art can be selected within the generic disclosure, and examples are not to be interpreted as limiting, unless specifically so indicated. The invention is not otherwise limited, except for the recitation of the claims set forth below. All references cited herein are incorporated in their entirety.

What is claimed is:

1. A method for treating a contaminated fluid comprising the steps of:
packing a column with a cellulose-based material;
passing said contaminated fluid through said packed column where contaminants are adsorbed onto said cellulose-based material until said cellulose-based material is spent;
removing said spent cellulose-based material; and
composting said spent cellulose-based material to reduce the volume of spent cellulose-based material and degrade and concentrate said contaminants.

2. The method of claim 1, wherein said cellulose-based material is selected from the group consisting of hay, wood, chips, peat, nut shells and kenaf.

3. The method of claim 1, wherein said contaminated fluid is passed through said column by up-flow hydraulics.

4. The method of claim 1, wherein said composting occurs on-site.

5. The method of claim 2, wherein said cellulose-based material is kenaf fibers.

6. The method of claim 1, wherein said contaminated fluid is selected from the group consisting of contaminated water and air.

7. The method of claim 1, wherein said composted material is substantially free from biodegradable contaminants.

8. The method of claim 1, wherein said contaminants are selected from the group consisting of organic contaminants and inorganic contaminants.

9. The method of claim 8, wherein said organic contaminants are selected from the group consisting of TNT, phenols, PCBs, petroleum products, MTBE, chlorinated solvents, and ketones.

10. The method of claim 8, wherein said inorganic contaminants are selected from the group consisting of cadmium, chromium, arsenic, mercury, nickel, copper, zinc, lead, nitrate, ammonia and phosphates.

11. The method of claim 7, wherein over 50% of the spent material is reduced.

12. The method of claim 5, wherein over 75% of said contaminants in said contaminated fluid is removed.

13. The method of claim 1, wherein over 75% of said contaminants in said contaminated fluid is removed.

14. The method of claim 1, wherein non-biodegradable adsorbates within said composted cellulose-based material are formed into a solid matrix.
